(19) United States
(12) Patent Application Publication
(10) Pub. No.: US 2005/0269968 A1
(43) Pub. Date: Dec. 8, 2005

(54) Power supply device and vehicle lamp

(75) Inventors: Masayasu Ito, Shizuoka (JP); Kentarou Murakami, Shizuoka (JP); Hitoshi Takeda, Shizuoka (JP)

Correspondence Address: OSHA LIANG L.L.P., 1221 MCKINNEY STREET, SUITE 2800, HOUSTON, TX, 77010, US

(73) Assignee: KOITO MANUFACTURING CO., LTD., Tokyo (JP)

(21) Appl. No.: 11/144,865

(22) Filed: Jun. 3, 2005

(30) Foreign Application Priority Data
Jun. 7, 2004 (JP) JP2004-169166

(51) Int. Cl. H05B 41/16

(52) U.S. Cl. 315/282

(57) ABSTRACT

A power supply device includes: a regulator transformer; a primary switch for selectively supplying a current to the regulator transformer; a control circuit for reducing to 0, following each election made at the primary switch, the minimum value of a current output by the secondary side of the regulator transformer; and a coupling transformer for magnetically coupling routes along which a plurality of loads are connected in parallel to the secondary side of the regulator translator in a direction in which magnetic flux along each of the routes is offset by a current change. In this case, the control circuit increases the maximum value of the output current on the secondary side larger than twice of the target value of the current supplied to the loads.

The present application claims foreign priority based on Japanese Patent Application No. 2004-169166, filed Jun. 7, 2004, the contents of which is incorporated herein by reference.

### BACKGROUND OF THE INVENTION

1. Technical Field

The present invention relates to a power supply device and a vehicle lamp.

2. Related Art

Conventionally, a vehicle lamp employing a light-emitting diode device is well known (see, for example, JP-A-2002-231013). When the vehicle lamp is turned on, the light-emitting diode element generates a forward voltage based on a predetermined threshold voltage at both ends.

A wide discrepancy appears in the forward voltage generated by individual light-emitting diode devices. Therefore, to cope with the discrepancy in the forward voltage, the vehicle lamp should be turned on by controlling the current for the light-emitting diode device. However, there is a case wherein, because of light distribution design, a vehicle lamp employs a plurality of light-emitting diode devices connected in parallel. In this case, wherein a separate circuit must be designated for supplying a current to each row, the circuit size would be increased, and accordingly, the cost of the vehicle lamp would be increased.

### SUMMARY OF THE INVENTION

Accordingly, one or more embodiments of the present invention provide a power supply device and a vehicle lamp that employ a set of the features described in the independent claims of the present invention. The dependent claims of the invention specifically define additional effective examples for the present invention.

According to a first aspect of the invention, a power supply device comprises:

a regulator transformer;

a primary switch, for selectively supplying a current to the regulator transformer;

a control circuit for reducing to 0, following each election made at the primary switch, the minimum value of a current output by the secondary side of the regulator transformer; and

a coupling transformer for magnetically coupling routes along which a plurality of loads are connected in parallel to the secondary side of the regulator translator in a direction |in which magnetic flux along each of the routes is offset by a current change. Since each time a selection is made at the primary switch the control circuit reduces to 0 the minimum value of the current output by the secondary side of the regulator transformer, currents can be supplied at desired rates for a plurality of loads.

Further, the control circuit increases a maximum value for the current output by the secondary side until larger than twice the target value of the currents to be supplied to the loads. Thus, when the minimum value of the current on the secondary side is 0, the average value of the output current can easily approach the target value. In addition, since the control circuit changes switching frequencies in accordance with a voltage supplied by the primary side, the average current on the secondary side is maintained, regardless of the voltage supplied by the primary side. Thus, an average value for the current on the secondary side can be maintained, without the maximum value of the current on the secondary side being changed at the time an election is made using the primary switch. Accordingly, the power lost by the switching regulator can be minimized.

Furthermore, when a target value for a current to be supplied for the loads connected in parallel to the secondary side of the regulator transformer is increased, the control circuit reduces a switching frequency for the primary switch to increase the average current on the secondary side. Thus, on the secondary side, the average value of the current can be increased without the range of the increase in the current being changed at the time the primary switch is used to make an election.

In this case, regardless of the target value of the current to be supplied for the loads, or the supply voltage on the primary side, the control circuit is maintained substantially constant for a period wherein the current output by the secondary side is 0 during a switching cycle time. Thus, when the target value for the current is small, or when the supply voltage is high, the power loss can be reduced. Accordingly, for the power supply device, a temperature rise can be suppressed, a service life reduction can be prevented, and reliability can be improved.

According to a second aspect of the invention, a vehicle lamp comprises:

a regulator transformer;

a primary switch for selectively supplying a current to the regulator transformer;

a plurality of semiconductor light-emitting devices, connected in parallel to a secondary side of the regulator transformer;

a control circuit for reducing to 0, each time a selection is made using the primary switch, the minimum value of a current output by the secondary side of the regulator transformer; and

a coupling transformer for magnetically coupling routes for the individual semiconductor light-emitting devices in a direction in which magnetic flux is offset by a current change.

In this case, regardless of the target value of the current to be supplied for the semiconductor light-emitting devices, or the supply voltage on the primary side, the control circuit is maintained substantially constant for a period wherein the current output by the secondary side is 0 during a switching cycle time.

The summary above does not include descriptions of all the features or of all the sub-combinations of features that can be included without departing from the spirit of the invention.

### BRIEF DESCRIPTION OF THE DRAWINGS

FIG. 1 is a diagram showing the structure of a vehicle lamp, together with a reference voltage source, according to one embodiment of the present invention.

FIGS. 2A and 2B are diagrams for explaining one example operation for a power supply device.

FIG. 3 is a diagram showing another example for a power supply transformer.

FIGS. 4A to 4C are diagrams for explaining example relationships between a gate voltage at a switching device and a current flowing through a secondary coil.

FIGS. 5A to 5C are diagrams for explaining example relationships between a gate voltage at the switching device and a current flowing through the secondary coil.

FIGS. 6A and 6B are diagrams for explaining example relationships between a gate voltage at the switching device and a current flowing through the secondary coil.

FIG. 7 is a diagram showing an example structure for a voltage rise detector.

FIG. 8 is a diagram showing an example structure for a current detector, together with a plurality of series resistors.

FIG. 9 is a diagram showing another example for the structures of an output current supply unit and an inductance current leakage supply unit.

FIG. 10 is a diagram showing another example for the structure of a voltage output unit.

FIG. 11 is a diagram showing another example for the structure of the vehicle lamp.

FIG. 12 is a diagram showing an additional example for the structure of the vehicle lamp.

### DETAILED DESCRIPTION OF THE INVENTION

Embodiments of the present invention will now be described. Note, however, that the present invention is not limited to these embodiments, and not all the feature sets described in these embodiments are always required by the present invention.

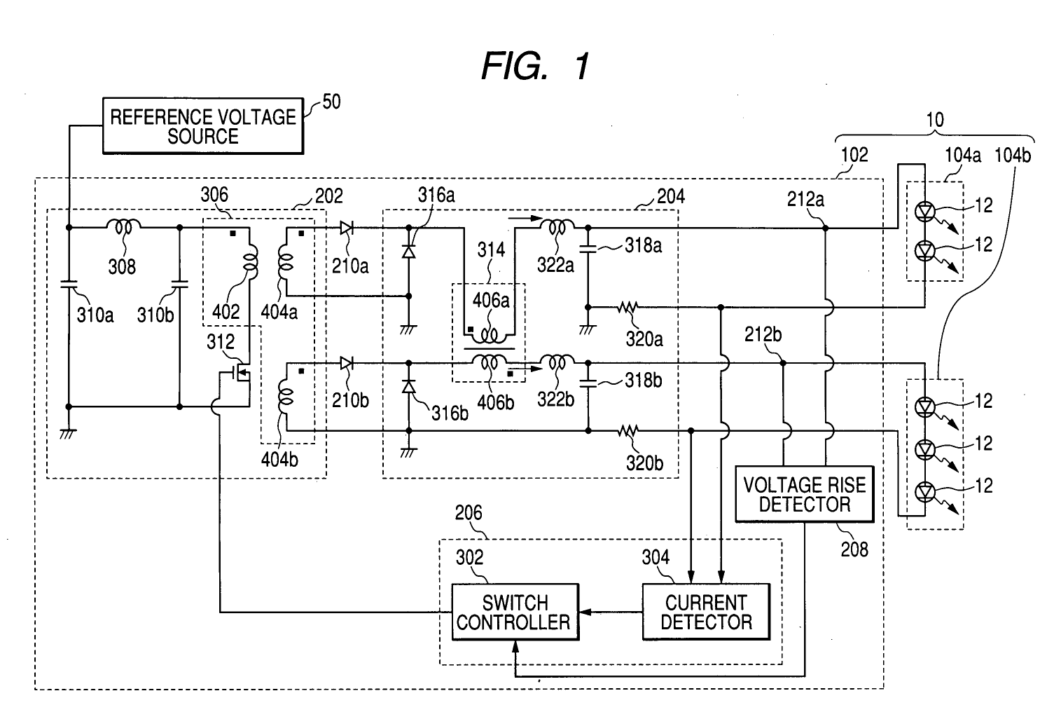

FIG. 1 is a diagram showing the configuration, according to one embodiment of the present invention, of a vehicle lamp 10 and a reference voltage power source 50. The reference power source 50, for example, is a vehicular-mounted battery that supplies a predetermined direct-current voltage to a power supply device 102. In this embodiment, the vehicle lamp 10 includes a plurality of light sources 104a and 104b and the power supply device 102. The embodiment provides a power supply device 102 that can supply a current, at a desired ratio, to the light sources 104a and 104b.

The light sources 104a and 104b are example loads, connected to the power supply device 102, that are connected in parallel and include one or more light-emitting diode devices 12. In one embodiment of the invention, the light-emitting diode devices 12 are example semiconductor light-emitting devices that generate light in accordance with power received from the power supply device 102.

The light sources 104a and 104b may have a different number of light-emitting diode devices 12, and may have a plurality of light source arrays connected in series. The light source arrays are, for example, one or more serially connected arrays of the light-emitting diode devices 12.

The power supply device 102 includes: a voltage output unit 202; a plurality of output current supply units 210a and 210b; a current ratio setup unit 204; a voltage rise detector 208; and an output controller 206. The voltage output unit 202 includes: a coil 308; a plurality of capacitors 310a and 310b; a switching device 312; and a power supply transformer 306.

The coil 308, connected in series to a primary coil 402 of the power supply transformer 306, supplies the output voltage of the reference voltage power source 50 to the power supply transformer 306. The capacitors 310a and 310b smooth voltages at both ends of the coil 308. The switching device 312, which is an example primary switch for one embodiment of the invention, is connected in series to the primary coil 402 of the power supply transformer 306, such that rendering the output of the switching device 312 on or off by the output controller 206 selects whether or not a current is supplied to the power supply transformer 306.

The power supply transformer 306, which is an example regulator transformer for one embodiment of the invention, includes the primary coil 402 and a plurality of secondary coils 404a and 404b. When the switching device 312 is rendered on, the primary coil 402 transmits, via the coil 308, a current received from the reference voltage power source 50. The secondary coils 404a and 404b that are provided correspond to the light sources 104a and 104b, and transmit to the corresponding light sources 104a and 104b, via the output current supply unit 210 and the current ratio setup unit 204, a voltage or a current that are consonant with the current that flows across the primary coil 402 and the voltage applied at both ends of the primary coil 402. As a result, the voltage output unit 202 supplies the voltage and the current to the light sources 104a and 104b. It should be noted that the secondary coils 404a and 404b may have the same number of turns, but consonant with the number of turns, may output different voltages.

The current output supply units 210a and 210b are diodes provided in consonance with the secondary coils 404a and 404b, and are connected in the forward direction between the secondary coils 404a and 404b. With this structure, the output current supply unit 210a and 210b can supply to the light source 104a and 104b, via the current ratio setup unit 204, voltages and currents output by the corresponding secondary coils 404a and 404b.

The current ratio setup unit 204 includes: a plurality of capacitors 310a and 310b; a plurality of series resistances 320a and 320b; an output transformer 314; a plurality of inductance current leakage supply units 316a and 316b; and a plurality of coils 322a and 322b. The capacitors 318a and 318b and the series resistors 320a and 320b are provided, in correspondence with the light sources 104a and 104b, and the capacitors 318a and 318b smooth a current flowing across the corresponding light sources 104a and 104b. The series resistors 320a and 320b are serially connected to the corresponding light sources 104a and 104b, and at both ends, generate voltages in consonance with a current flowing through the corresponding light sources 104a and 104b.

The output transformer 314, which is an example coupling transformer for one embodiment of the invention, includes a plurality of output coils 406a and 406b. The output coils 406a and 406b are provided in correspondence with the light sources 104a and 104b; and the output coil 406a is connected via the coil 322a to the corresponding light source 104a, while the output coil 406b is connected via the coil 322b to the corresponding light source 104b. The output coils 406a and 406b transmit, to the corresponding light sources 104a and 104b, a current supplied by the voltage output unit 202. It should be noted that the light emitting diodes 12 in the light source 104a or 104b are connected in series to the corresponding coil 406a or 406b via the coil 322a or 322.

In this embodiment, the output coils 406a and 406b are wound in opposite directions. Therefore, in accordance with the current supplied to the light sources 104a and 104b by the voltage output unit 202, the output coils 406a and 406b generate magnetic fluxes in a direction in which they cancel each other. Further, since the output coils 406a and 406b in a transformer are coupled, the ratio at which a current flows through the output coil 406a and the output coil 406b is the opposite of that of the turn ratio. Thus, the coils 322a and 322b may represent a flux leakage by the output transformer 314. In this case, the inductances of coils 322a and 322b are proportional to the squares of the turn ratios of the corresponding output coils 406a and 406b.

The leakage inductance current supply units 316a and 316b are diodes provided in correspondence with the output coils 406a and 406b. The leakage inductance current supply units 316a and 316b are connected in opposite directions between the cathodes of diodes that constitute the output current supply units 210a and 210b and the low potential output terminals of the secondary coils 404a and 404b to which the anodes of these diodes are connected. In this case, the inductance current leakage supply units 316a and 316b discharge to the capacitors 318a and 318b, via the corresponding output coils 406a and 406b, energy accumulated by the corresponding coils 322a and 322b. Thus, when currents supplied by the voltage output units 202a and 202b to the light source units 104a and 104b are reduced, the inductance current leakage supply units 316a and 316b supply to the light sources 104a and 104b currents in amounts consonant with the corresponding coils 322.

In one embodiment, the inductance current leakage supply units 316a and 316b constitute a forward converter, in addition to the power supply transformers 306a and 306b, the switching device 312, the output current supply units 210a and 210b, the output coils 406a and 406b and the coils 322a and 322b.

During the period the switching device 312 is OFF, the inductance current leakage supply units 316a and 316b discharge, to the capacitors 318a and 318b, energy accumulated by the coils 322a and 322b during the period of the switching device 312 was ON.

When, for example, the inductance current leakage supply units 316a and 316b are not employed, energy accumulated by the coils 322a and 322b would be a loss during the period the switching device 312 is OFF. However, according to this embodiment, the energy accumulated by the coils 322a and 322b can be efficiently provided for the light sources 104a and 104b.

The voltage rise detector 208 detects the elevation of a voltage applied to each of the light sources 104a and 104b.

This is a voltage supplied to a node a and a node b, which are located between the light sources 104a and 104b and the corresponding coils 322a and 322b, and is, for example, an absolute value for a difference between the potentials of the nodes 212 and a ground potential. The voltage rise detector 208 detects, relative to the light sources 104a and 104b, that the voltages at the nodes 212 exceed a predesignated value.

Or, the voltage rise detector 208 may detect an elevation of the absolute values of the potentials at the nodes 212.

The output controller 206, which is an example control circuit of one embodiment of the invention, includes a current detector 304 and a switch controller 302. The current detector 304 detects voltages at both ends of each of the series resistors 320a and 320b, and detects currents flowing through the light source 104a or 104b that correspond to the series resistor 320a or 320b. The switch controller 302 performs, for example, the well known PWM control or PFM control in accordance with the current detected by the current detector 304, and controls the ON or OFF time of the switching device 312. In this manner, the switch controller 302 controls the switching device 312, so that a constant current value is detected by the current detector 304. In one embodiment, the values of the currents flowing through both the light sources 104a and 104b are detected; however, since the current ratios are designated in advance by the output transformer 314, only the current flowing through one of the light sources 104 may be detected.

When the voltage rise detector 208 detects at the nodes 212a and 212b the elevation of the voltage for either light source 104a or 104b, the switch controller 302 maintains the OFF condition of the switching device 320 and halts the output of the voltage by the voltage output unit 202. Thus, the output controller 206 provides a failsafe function for halting the power supply device 102 upon the occurrence of an abnormality, and provides improved safety for the power supply device 102.

In another example, the switch controller 302 may selectively halt the output by the voltage output unit 202 of the voltage to the light source 104, for which the voltage elevation at the node 212 is detected. In this case, a light source unaffected by the abnormality can be continuously on. As a result, a vehicle lamp 10 can be provided that has a high redundancy relative to failures.

Because, for example, of the light distribution design of the vehicle lamp 10, light sources 104a and 104b, for which required voltage values and current values differ, may be employed. In this case, when a power supply device 102 is provided for each of the light sources 104, costs would be increased. However, according to embodiments of the invention, in the single power supply device 102, the secondary coils 404a and 404b are individually provided for the light sources 104a and 104b, so that an appropriate voltage can be applied for each of the individual light sources 104a and 104b. Further, since the output transformer 314 is employed for which the output coils 406a and 406b are provided, an appropriate current ratio can be designated for the supply of a current to the light sources 104a and 104b. Thus, according to embodiments of the invention, the cost of properly turning on the light sources 104a and 104b can be low, and a vehicle lamp 10 can be provided at a low cost.

As another example, the output coils 406a and 406b of the output transformer 314 may be wound in the same direction. In this case, the output coils 406a and 406b both generate magnetic fluxes in a direction in which each magnetic flux is increased by the other, and accordingly, voltages are generated at their ends in consonance with the ratio of the number of turns. Therefore, in this case, it is preferable that the number of turns for the coils 406a and 406b be consonant with the voltages to be applied to their corresponding light sources 104a and 104b.

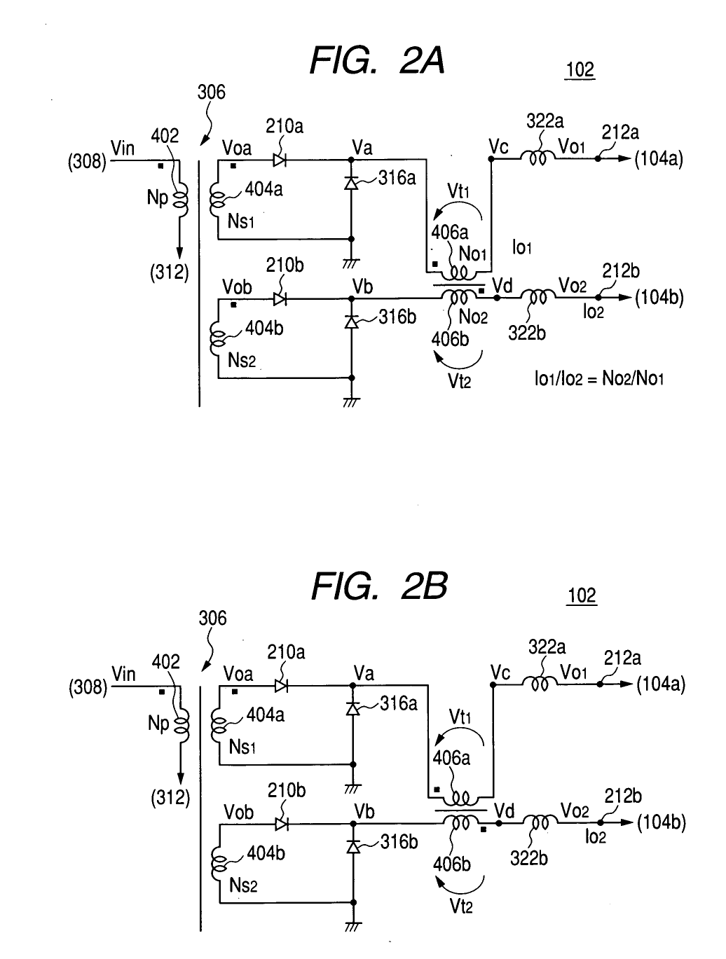

FIGS. 2A and 2B are diagrams for explaining an example operation performed by the power supply device 102. In FIGS. 2A and 2B, only portions required for the explanation are extracted from the power supply device 102. In FIG. 2A, the power supply device 102 shown is one for which normal light sources 104a and 104b are provided. In FIG. 2B, the power supply device 102 shown is one when only the light source 104a is open. The open state represents a condition wherein the section between the node 212 and the ground potential terminal is in a high impedance state, resulting, for example, from the disconnection of the light source 104.

In one embodiment, the number of turns for the primary coil 402 is Nₚ, the number of turns for both the secondary coils 404a and 404b are Nₙ₁ and Nₙ₂, and the number of turns for both the output coils 406a and 406b are Nₒ₁ and Nₒ₂. The secondary coils 404a and 404b are connected in series to the corresponding light sources 104a and 104b and the output coils 406a and 406b and the coils 322a and 322b, which correspond to the light sources 104a and 104b.

The primary coil 402 receives a predetermined supply voltage Vᵢₙ from the reference voltage power source (see FIG. 1) via the coil 308. In this case, the secondary coil 404a outputs a terminal voltage Vₐ, denoting Vₒₐ=Vᵢₙ·Nₛ₁/Nₚ, while the secondary coil 404b outputs a terminal voltage V_{b}, denoting V_{ob}=Vᵢₙ·Nₐ₂/Nₚ.

As is shown in FIG. 2A, when the light sources 104a and 104b are normal, the output coils 406a and 406b transmit currents Iₒ₁ and Iₒ₂, for which Iₒ₁/Iₒ₂=Nₒ₂/Nₒ₁ is established. Thus, the current ratio setup unit 204 (see FIG. 1) designates a ratio for the currents flowing through the light sources 104a and 104b.

Then, voltages Vₒ₁ and Vₒ₂ are applied at the nodes 212a and 212b, wherein Vₒ₁=Vₐ−Vₜ₁−V_{L1} and Vₒ₂=V_{b}−Vₜ₂−V_{L2}. Vₜ₁ denotes a voltage generated at the output coil 406a; Vₜ₂ denotes a voltage generated at the output coil 406b; V_{L1} denotes a voltage generated at the coil 322a and represents the magnetic flux leakage at the output coil 406a; and V_{L2} denotes a voltage generated at the coil 322b and represents the magnetic flux leakage at the output coil 406b.

Since the output coils 406a and 406b are wound in a direction that permits the magnetic fluxes to cancel each other, the inductances at the output coils 406a and 406b are nearly zero. Further, the output coils 406a and 406b may be wound near each other, like sandwiches, to reduce the magnetic flux leakage, and special coils 322a and 322b may be separately provided for the magnetic flux leakages. Either this, or the size of the windings of the output coils 406a and 406b maybe intentionally enlarged to increase the magnetic flux leakage, and magnetic flux leakages 322a and 322b may result. Thus, the inductances L₁ and L₂ of the coils 322a and 322b, which represent the magnetic flux leakages, limit the currents and determine the inclinations of the rise and the fall of the current. Therefore, when the light sources 104a and 104b are normal, the only inductance elements present between the power supply transformer 306 and the light sources 104 are L₁ and L₂.

When only the light source 104a is open, as is shown in FIG. 2B, the terminal voltages Vₐ and V_{b} of the secondary coils 404a and 404b are unchanged because these voltages are determined in accordance with Vᵢₙ and the turn ratio of the power supply transformer 306. However, the output coil 406a, which corresponds to the light source 104a, accumulates energy in consonance with a current that flows across the output coil 406b. At this time, a voltage Vₜ₁, for which Vₜ₁=Vₜ₂·Nₒ₁/Nₒ₂ is established, is applied at both ends of the output coil 406a. Further, since the light source 104a is open, no current flows through the coil 322a and V_{L1} is zero. As a result, the output coil 406a outputs to the node 212a a voltage Vₒ₁ for which Vₒ₁=Vₐ+Vₜ₁=Vₐ+Vₜ₂·Nₒ₁/Nₒ₂ is established. Therefore, the voltage at the node 212a, which corresponds to the light source 104a in the open state, is increased, compared with when the light source 104a is normal. Further, the inductance element for the light source 104b is the sum of those for the output coil 406b and the coil 322b (L₂), and is larger than the inductance element in the normal state.

Since the terminal voltages Vₐ and V_{b} for the secondary coils 404a and 404b are unchanged when the light source 104a is open, to provide notification, by detecting these terminal voltages, that the open state exists is difficult. However, in this embodiment, since the voltage rise detector 208 (see FIG. 1) detects an increase in the voltage Vₒ₁ or Vₒ₂ at the node 212a or 212b, and the switch controller 302 (see FIG. 1) halts the power supply device 102, the open state of the light source 104 can be appropriately detected. Further, with this arrangement, the failsafe control for the open state of the light source 104, and/or the control of a multiple light source 104 redundancy, can be appropriately performed. That is, only the light source 104b can be turned on or off, and at this time, the switch controller functions as a simple one-output forward converter having a comparatively large inductance element.

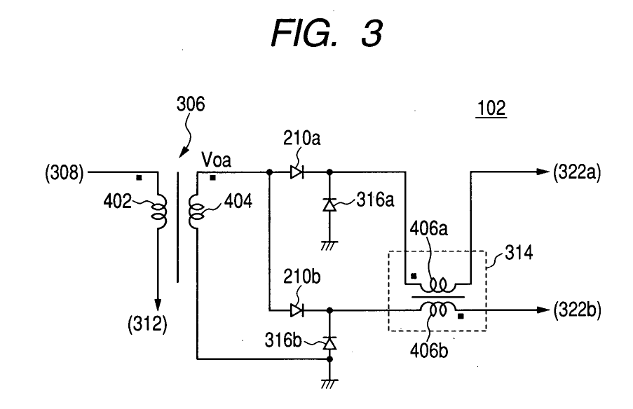

FIG. 3 is a diagram showing another example for the power supply transformer 306. Since the components denoted in FIG. 3 by the same reference numerals as those used in FIG. 1 have the same or corresponding functions, no further explanation for them will be given. The power supply transformer 306 includes the primary coil 402 and the secondary coil 404. The secondary coil 404 generates a voltage in accordance with a current that flows via the primary coil 402 and the turn ratio, relative to the primary coil 402. One end of the secondary coil 404 is connected to the anodes of the output current supply units 210a and 210b; the other end is grounded.

In this example, a single power supply device 102 must be employed only to apply an appropriate voltage to the individual light sources 104. Further, since the power supply transformer 306 having one output coil 406 can be employed to supply a voltage to the light sources 104, the number of devices required can be reduced, compared with when the power supply transformer 306 has a plurality of secondary coils 404. Therefore, both the size and the cost of the power supply device 102 can be reduced.

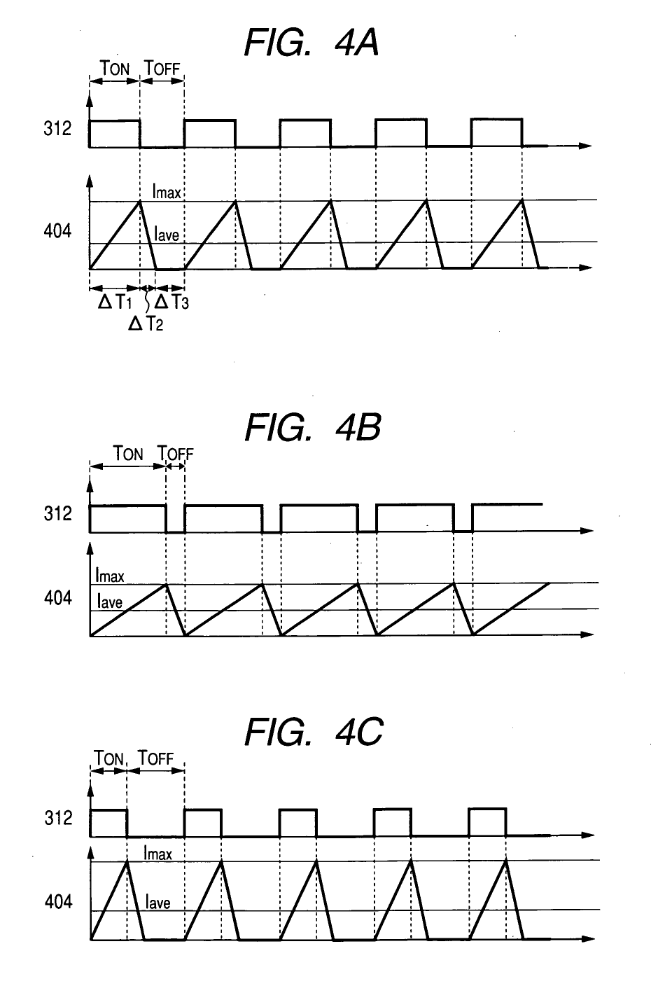

FIGS. 4A to 4C are diagrams for explaining a relationship between the gate voltage for the switching device and the current flowing through the secondary coil, 404. In FIG. 4A is shown an example relationship between the gate voltage for the switching device 312 and the current transmitted via the secondary coil 404. In FIG. 4B is shown an example relationship between the gate voltage for the switching device 312 and the current transmitted via the secondary coil 404 when the voltage supplied to the power supply transformer 306 is lower than that in FIG. 4A. In FIG. 4C is shown an example relationship between the gate voltage for the switching device and the current across the secondary coil 404 when a voltage is to be supplied that is higher than that in FIG. 4A.

In one embodiment, during a predesignated period, the output controller 206 performs the well known PWM control, and applies a High voltage and a Low voltage to the gate terminal of the switching device 312. In FIGS. 4A to 4C, T_{ON} represents a time in one period during which the switching device 312 receives at the gate terminal the High voltage output by the output controller 206; and T_{OFF} represents a time in one period during which the switching device 312 receives a Low voltage from the output controller 206 at the gate terminal. The switching device 312 is turned on in the T_{ON} period, and transmits a current to the primary coil 402, while the switching device 312 is turned off in the T_{OFF} period, and halts the transmission of a current to the primary coil 402.

In the case shown in FIG. 4A, during the T_{ON} period, the switching device 312 continues to supply a current to the primary coil 402, so that the current flowing through the secondary coil 404 is increased until the switching device 312 is turned off. During this period, the current is transmitted via the secondary coil 404, the output current supply unit 210, the output coil 406, the coil 322 and the capacitor 318. Further, since the rate at which to increase the current flowing through the secondary coil 404 depends on the supply voltage Vᵢₙ, when the supply voltage Vᵢₙ is high, the current flowing across the secondary coil 404 is sharply increased and ΔT₁ is shortened. Whereas when the supply voltage Vᵢ is low, the current flowing across the secondary coil 404 is moderately increased, and ΔT₁ is extended.

When the switching device 312 is turned off by the output controller 206, a current is supplied via the inductance current leakage supply unit 316, the output coil 406, the coil 311 and the capacitor 318, so that the strength of the current flowing through the output coil 406 is reduced. The rate at which to reduce the current in the output coil 406 does not depend on the supply voltage Vᵢₙ, and is determined by a circuit constant. An average current Iₐᵥₑ is supplied by the capacitor 318 to the light source 104 and the series resistor 320.

As is described above, during the T_{ON} period, the output controller 206 supplies a current to the primary coil 402, and during the T_{OFF} period, halts the current flowing through the primary coil 402, so as to supply, to the secondary coil 404, a current that is increased during a period ΔT₁ or reduced during a period ΔT₂. Furthermore, the output controller 206 controls the duty ratio of the pulse so that the T_{OFF} period is longer than the ΔT₂ period. Thus, the current flowing through the secondary coil 404 is adjusted to zero during a period represented by ΔT₃. As is described above, under the control exercised by the switching controller 302, the switching device 312 is repetitively turned on or off, and the output coil 406 transmits a saw-wave shaped current, as is shown in FIG. 4A, that includes the period wherein no current was flowing. A current flowing through the output coil 406 is smoothed by the coil 322 and the capacitor 318, and the resultant current is supplied to the light source 104. When the maximum value of the current flowing through the output coil 406 is defined as Iₘₐₓ, and the average current smoothed and supplied to the light source 104 is Iₐᵥₑ, the output controller 206 controls the T_{ON} time so that Iₘₐₓ is greater than twice of Iₐᵥₑ.

The relationship between the voltages and the current at the individual sections will now be described in detail while referring to FIG. 2A. Assuming that Vₐₒₙ, V_{bon}, V_{con} and V_{don} denote voltages of Vₐ, V_{b}, V_{c} and V_{d} when the switching device 312 is on, the following relation is established.
Vₐₒₙ=Vᵢₙ(N_{S1}/N_{P})−V_{f} Ex. 1
V_{bon}=Vᵢₙ(N_{S2}/N_{P})−V_{f} Ex. 2
Nₒ₁/Nₒ₂=(V_{con}−Vₐₒₙ)/(V_{bon}−V_{don}) Ex. 3
Nₒ₁/Nₒ₂=((V_{don}−Vₒ₂)/L₂)/((V_{con}−Vₒ₁)/L₁) Ex. 4

Assuming that V_{aoff}, V_{boff}, V_{coff} and V_{doff} denote voltages of Vₐ, V_{b}, V_{c} and V_{d} when the switching device 312 is off, the following relation is established.
V_{aoff}=V_{boff}=−V_{f} Ex. 5
Nₒ₁/Nₒ₂=(V_{aoff}−V_{coff})/(V_{doff}−V_{boff}) Ex. 6
Nₒ₁/Nₒ₂=((Vₒ₂−V_{doff})/L₂)/((Vₒ₁−V_{coff})/L₁) Ex. 7

In this case, V_{f} denotes a voltage drop at the diode provided for the output current supply unit and the inductance current leakage supply unit.

Further, in expressions 1 to 4 and expressions 5 to 7, the ratio of Vₐₒₙ to V_{bon} completely equals to the ratio of Vₒ₁ to Vₒ₂, the same amount of energy that the output coil 406b provided for the output coil 406a during the ON period for the switching device 312 was returned by the output coil 406a to the output coil 406b during the OFF period for the switching device 312. However, a wide discrepancy appears in the forward voltage for the individual light-emitting diode devices 12 included in the light sources 104 and the forward voltage for the light-emitting diode device 12 is changed in accordance with the temperature, and also, a variance appears in the voltage change for the individual light-emitting diode devices. Therefore, it is difficult for the ratio Vₒ₁ to Vₒ₂ to match the ratio Vₐₒₙ to V_{bon}. Therefore, when the ratio Vₐₒₙ to V_{bon} differs from the ratio of Vₒ₁ to Vₒ₂, the amount of energy that differs from the amount of energy that the output coil 406a provided for the output coil 406b during the ON period of the switching device 312 is returned by the output coil 406a to the output coil 406b during the OFF period for the switching device 312. Accordingly, an energy deviation occurs between the output coils 406a and 406b, and the output transformer 314 is unevenly magnetized.

When the output transformer 314 is unevenly magnetized, a direct current would be retained in one of the output coils 406a or 406b. Then, the current consumed by the power supply device 102 would be increased, and the power supply device 102 would be damaged by the heat that it generates. Further, when uneven magnetization is accumulated, magnetic fluxes at the cores of the power supply transformer 306 and the output transformer 314 would be saturated, so that either the amount of current supplied to the light sources 104 is reduced or the light sources 104 are not appropriately turned on. Further, since the output controller 206 controls the switching device 312 to maintain a desired value for a current to be supplied to the light sources 104, the switching device 312 would be damaged by generated heat.

However, in one embodiment, for each switch process at the switching device 312, the output controller 206 extends the T_{OFF} until it is longer than ΔT₂, and reduces, to zero, the minimum value of the output current at the secondary coil 404. Thus, there is a moment whereat the amount of current present in the output transformer 314 is zero. Therefore, uneven magnetization does not occur on the output transformer 314, and a direct current is not retained in the output transformer 314. Thus, heat generation by the power supply device 102 can be prevented, and current can be supplied to multiple light sources 104 at a desired ratio. It should be noted, however, that the amount of energy exchanged by the output coils 406a and 406b should match, to the extent possible, to prevent uneven magnetization, and that the ratio Vₐₒₙ to V_{bon} and the ratio Vₒ₁ to Vₒ₂ should be so designated that they are as equal as possible in order to reduce a loss due to uneven magnetization.

When ΔI₁ and ΔI₂ denote changes in the amount of the currents flowing through the output coils 406a and 406b, L₁ and L₂ denote inductances for the coils 322a and 322b, Tₒₙ denotes the period wherein the switching device 312 is on, and T_{off} denotes the period wherein the switching device 312 is off, the following relationship is established.
ΔI₁=((V_{con}−Vₒ₁)/L₁)Tₒₙ=((Vₒ₁−V_{coff})/L₁) T_{off} Ex. 8
ΔI₂=((V_{don}−Vₒ₂)/L₂)Tₒₙ=((Vₒ₂−V_{doff})/L₂) T_{off} Ex. 9

The output controller 206 controls the T_{ON} period so that Iₘₐₓ, which is the maximum value of the current for the secondary coil 404, is twice as large as Iₐᵥₑ, which is the target value for a current to be supplied to the light sources 104. Through the provision of this control, when the minimum value of the current flowing through the secondary coil 404 is zero, the average value of the current supplied to the light sources 104 can easily be near the target value.

Furthermore, in one embodiment, when the voltage (Vᵢₙ) supplied to the power supply transformer 306 is reduced, as is shown in FIG. 4B, the output controller 206 extends the T_{ON} period and maintains a constant average current for supply to the light sources 104. Even in this case, the T_{OFF} period is adjusted so it is longer than the period ΔT₂, which is a period required for the reduction of the current flowing through the secondary coil 404. With this arrangement, the current can be supplied to the multiple light sources 104 at a desired ratio, and when the voltage (Vᵢₙ) supplied to the power supply transformer 306 is reduced, the supply of a constant average current to the light sources 104 can be maintained.

In addition, in one embodiment, when the voltage (Vᵢₙ) supplied to the power supply transformer 306 is increased, as is shown in FIG. 4C, the output controller 206 reduces the T_{ON} period and maintains the constant average current that is to be supplied to the light sources 104. In this case, the T_{OFF} period is much longer than the period ΔT₂, and uneven magnetization at the output transformer 314 does not occur.

Therefore, a current can be supplied to the multiple light sources 104 at a desired ratio, and when the voltage (Vᵢₙ) supplied to the power supply transformer 306 is changed, the supply to the light sources 104 of a constant average current can be maintained.

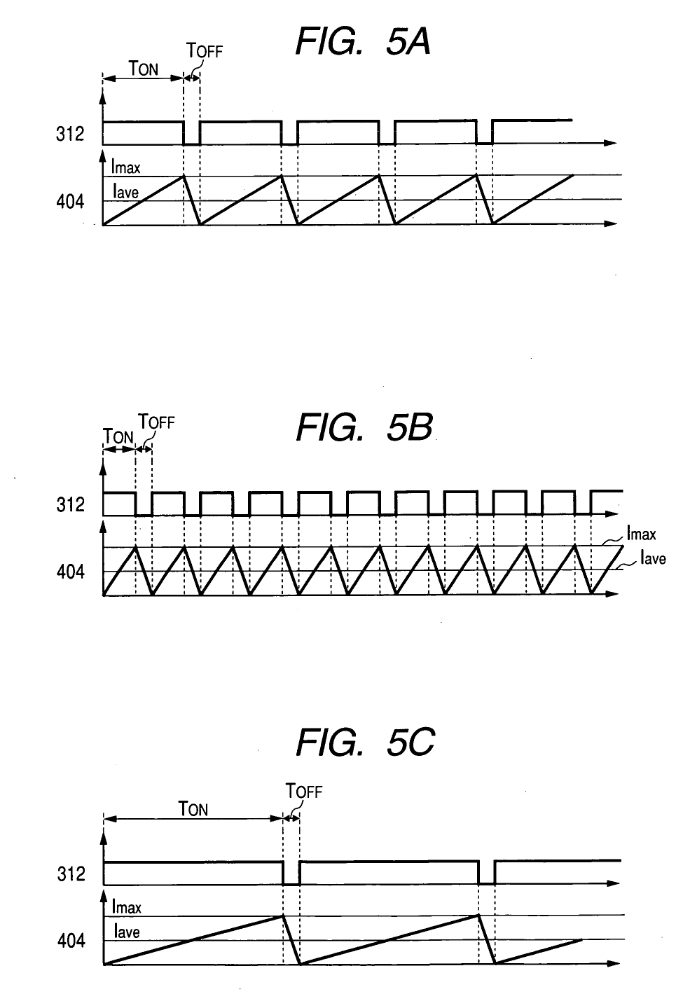

FIGS. 5A to 5C are diagrams for explaining another example OF the relationship between the gate voltage of the switching device 312 and the current in the secondary coil 404. In FIG. 5A is shown a relationship between the gate voltage at the switching device 312 and the current in the secondary coil 404. In FIG. 5B is shown a relationship between the gate voltage at the switching device and the current in the secondary coil 404 when the voltage supplied to the power supply transformer 306 is higher than in FIG. 5A. In FIG. 5C is shown a relationship between the gate voltage at the switching device 312 and the current in the secondary coil 404 when the voltage supplied is lower than in FIG. 5A.

In this example, the output controller 206 performs the well known PEM control during which the T_{OFF} period for outputting a Low voltage is constant, and applies a High voltage and a Low voltage to the gate terminal of the switching device 312. In this example, regardless of the voltage supplied to the power supply transformer 306 and the current supplied to the light sources 104, the T_{off} period is designated substantially equal to the time ΔT₂, during which the current reaches zero in the OFF time for the switching device 312. Therefore, as is shown in FIG. 5A, the time during which current flows through the secondary coil 404 is 0 is short. To obtain this setup, the T_{OFF} time need only be determined based on the values of Vₒ₁, Vₒ₂, L₁ and L₂, i.e., based on expressions 8 and 9.

Assuming that the time at which the current flowing through the secondary coil 404 is zero is long, the maximum value Iₘₐₓ of the current that flows through the secondary coil 404 during the ON period of the switching device 312 must be increased in order to supply a desired average current to the light sources 104. When the maximum value Iₘₐₓ of the current flowing through the secondary coil 404 is large, the power conversion efficiency of the power supply transformer 306 would be reduced. However, in this example, since the output controller 206 transmits, to the gate signal of the switching device 312, a PFM signal that designates a reduction in the time whereat the current flowing through the secondary coil 404 is zero, deterioration of the power conversion efficiency of the power supply transformer 306 can be prevented. Accordingly, a rise in the temperature of the power supply device 102, and a reduction in the service life of the power supply device 102 can be suppressed, and there liability of the power supply device 102 can be improved.

When the voltage supplied to the power supply device 102 is increased, and when the switching device 312 is turned on, the amount of current flowing through the secondary coil 404 is more sharply increased than in FIG. 5A. On the other hand, when the switching device 312 is turned off, the current flowing through the secondary coil 404 reaches zero at the time ΔT₂, as in FIG. 5A. In this example, as is shown in FIG. 5b, when the voltage supplied to the power supply transformer 306 is raised, the output controller 206 maintains the length of the period T_{OFF} so it is substantially equal to the period ΔT₂, and increases the frequency at which the switching device 312 is to be turned on or off. Through this process, even when the voltage supplied to the power supply transformer 306 is raised, the supply of a constant amount of current to the light sources 104 can be maintained.

When the voltage supplied to the power supply transformer 306 is dropped, and when the switching device 312 is turned on, the current flowing through the secondary coil 404 is more moderately increased than in FIG. 5A. On the other hand, when the switching device 312 is turned off, the current flowing through the secondary coil 404 reaches zero at the time ΔT₂, as in FIG. 5A. In this example, when the voltage supplied to the power supply transformer 306, shown in FIG. 5C, the output controller 206 maintains the length of the period T_{OFF} so it is substantially equal to the period ΔT₂, and reduces the switching frequency for the switching device 312 so as to maintain the supply of a constant current to the light sources 104. Through this process, the average current Iₐᵥₑ supplied to the light sources 104 can be maintained, without changing the maximum value Iₘₐₓ of the current that flows through the secondary coil 404 during the switching period for the switching device 312. As a result, power loss at the power supply transformer 306 can be minimized.

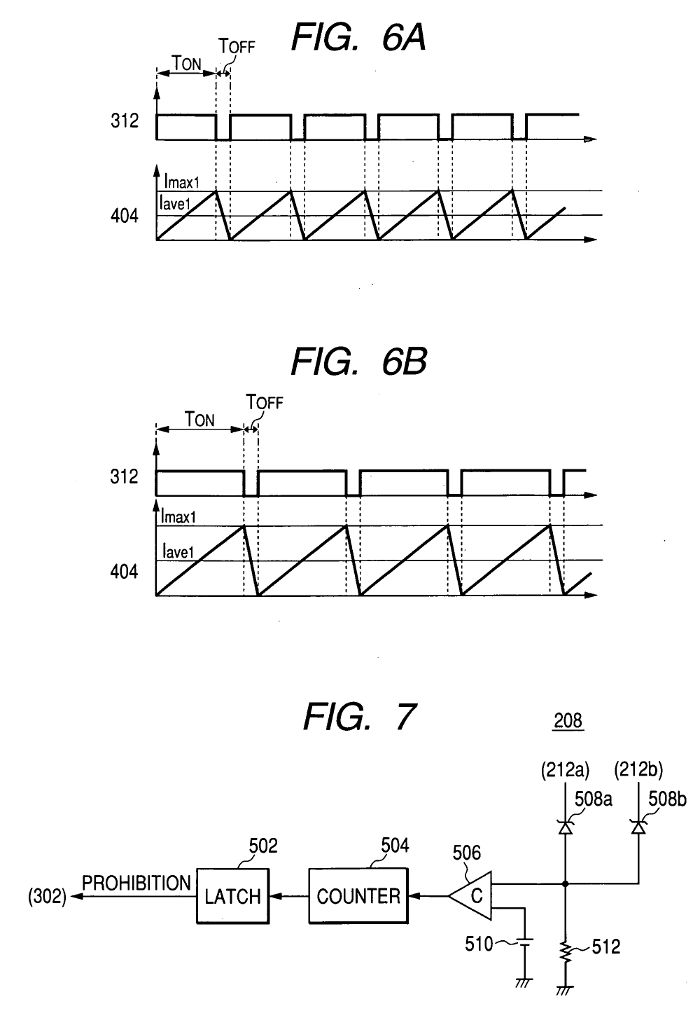

FIGS. 6A and 6B are diagrams for explaining an additional example for a relationship between the gate voltage at the switching device and the current flowing through the secondary coil 404. In FIG. 6A is shown the relationship between the gate voltage at the switching device 312 and the current flowing through the secondary coil 404. And in FIG. 6B is shown the relationship between the gate voltage at the switching device 312 and the current flowing through the secondary coil 404 when the average current to be supplied to the light sources 104 is raised more than in FIG. 6A.

In this example, the output controller 206 performs the well known PFM control wherein the period T_{OFF} is constant, and applies a High voltage and a Low voltage to the gate terminal of the switching device 312. Furthermore, in this embodiment, regardless of the voltage supplied to the power supply transformer 306 and the current supplied to the light sources 104, the period T_{OFF} is designated so it is substantially equal in the length of the period ΔT₂. In this example, the voltage Vᵢₙ supplied to the power supply transformer 306 is substantially constant.

As is shown in FIG. 6B, when the target value of the current supplied to the light sources 104 is increased from Iₐᵥₑ₁ to Iₐᵥₑ₂, the output controller 206 maintains the length of the period T_{OFF} 50 it is substantially equal to the period ΔT₂, and reduces the switching frequency for the switching device 312, so that the average current supplied to the light sources 104 is increased. Through this process, the average value for the current flowing through the secondary coil 404 can be increased, without changing the rate for the increase in the current that flows through the secondary coil 404 at the switching time for the switching device 312. As is apparent from expressions 8 and 9, the period T_{OFF} need only be extended by a value equivalent to an Iₐᵥₑ increase, i.e., an increase of ΔI.

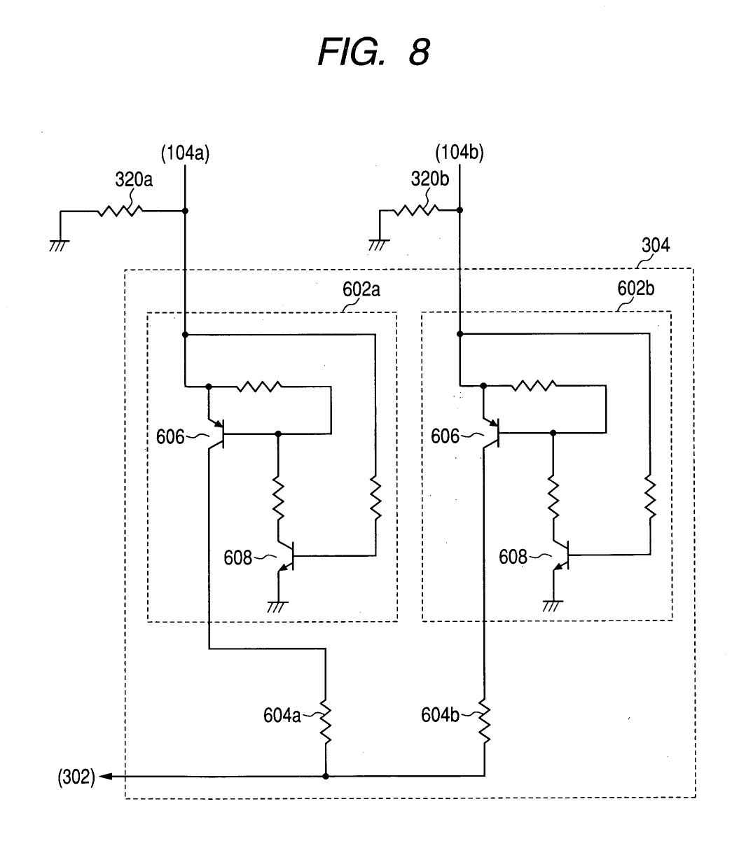

FIG. 7 is a diagram showing an example structure for the voltage rise detector 208. In this example, the voltage rise detector 208 includes: a plurality of Zener diodes 508a and 508b, a comparator 506, a resistor 512, a constant voltage source 510, a counter 504 and a latch 502. The Zener diodes 508a and 508b provided correspond to the light sources 104a and 104b (see FIG. 1), and the cathodes of the Zener diodes 508a and 508b are connected to the corresponding light sources 104a and 104b while the anodes are connected to one of the input terminals of the comparator 506. The other input terminal of the comparator 506 is grounded through the resistor 512. And when the voltage of the corresponding node 212 is higher than the Zener voltage, the Zener diode 508 provides the voltage at the node 212 to the comparator 506.

At the input terminal, the comparator 506 receives a predetermined voltage via the constant voltage source 510. Since the constant voltage source 510 provides for the comparator 506 a voltage lower than the Zener voltage at the Zener diode 508, the comparator 506 inverts the output when the voltage of either node 212 is higher than the Zener voltage at the Zener diode 508. Thus, an increase in the voltage at the node 212 that exceeds a predesignated value can be properly detected.

The counter 504 delays the output of the comparator 506, and supplies the output to the latch 502. The latch 502 latches the output of the counter 504, and transmits the obtained value to the switch controller 302. Thus, an abnormality, such as an open state of the light source 104, can be distinguished from a rise in the voltage due to a temporary voltage change caused by noise. Therefore, in this example, an increase in the voltage at the node 212 can be appropriately detected, and the open state of the light source 104, for example, can be properly detected.

In another example, the voltage rise detector 208 may include a plurality of resistors, instead of the multiple Zener diodes 508a and 508b. These resistors can be located between the node 212 and the comparator 506, instead of the Zener diodes 508. In this example, a rise in the voltage at the node 212 can also be appropriately detected.

FIG. 8 is a diagram showing an example structure of the current detector 304, as well as a plurality of series resistors 320a and 320b. In this example, the current detector 304 includes a plurality of disconnection detectors 602a and 602b and a plurality of resistors 604a and 604b, which correspond to the light sources 104a and 104b.

The disconnection detector 602 includes a PNP transistor 606, an NPN transistor 608 and a plurality of resistors. The base terminal of the PNP transistor 606 is connected to the emitter terminal via the resistor, and the emitter terminal is connected to a node located between the corresponding light source 104 and the series resistor 320. The collector terminal is connected to the corresponding resistor 604. The base terminal of the NPN transistor 608 is connected, via the resistor, to a node located between the corresponding light source 104 and the series resistor 320, and the collector terminal is connected, via the resistor, to the base terminal of the PNP transistor 606. The emitter terminal of the NPN transistor 608 is grounded. The resistor 604 connects the switch controller 302 and the collector terminal of the PNP transistor 606 of the corresponding disconnection detector 602.

When a corresponding light source 104 is not open, the potential at the node located between this light source 104 and the series resistor 320 is a product of the value of the current that flows through the light source 104 and across the resistance of the series resistor 320. In this case, the NPN transistor 608 and the PNP transistor 606 are rendered on, and the resistor 604 receives, from the disconnection detector 602, the voltage generated at both ends of the series resistor 320.

Furthermore, when the corresponding light source 104 is open because of a disconnection, a current does not flow through the series resistor 320, so that the potential at the node between the light source 104 and the series resistor 320 is a ground potential. In this case, the NPN transistor 608 and the PNP transistor 606 are rendered off, and the resistor 604 receives a high impedance from the disconnection detector 602.

When the light sources 104a and 104b are not open, the current detector 304 supplies to the switch controller 302, as a detected current value, the average value of the voltages generated at both ends of each of the series resistors 320a and 320b. When either light source 104a or 104b is open, the current detector 304 supplies to the switch controller 302, as a detected current value, the average value of the voltages generated at both ends at the series resistors 320a and 320b that are not open. Then, the switching controller 302 controls the switching device 312 (see FIG. 1), so that the voltage received from the current detector 304 is constant.

The series resistors 320 are connected in series to the light sources 104 and the output coils 406 (see FIG. 1) corresponding to the light sources 104. Therefore, when the corresponding light sources 104 are not open, a current flows across the series resistors 320a and 320b at a current ratio that is designated by the output coils 406a and 406b.

In this example, the series resistors 320 have resistances for which the ratio is the opposite of the ratio for the current flowing through the corresponding light sources 104. Therefore, in this example, the series resistors 320 generate substantially equal voltages in accordance with the currents flowing through the corresponding light sources 104. Therefore, according to this example, when the average value of the voltages generated at the ends of the individual series resistors are adjusted so they equal the setup voltage defined in common for a plurality of series resistors 320, the current flowing through the light sources 104a and 104b can be appropriately controlled. The output controller 206 (see FIG. 1) need only control the voltage output by the voltage output unit 202, for the voltages generated at the ends of the individual series resistors 320 to equal the setup voltage.

The vehicle lamp 10 (see FIG. 1) may have three or more light sources 104, and when one of the light sources 104 is open, the current detector 304 may supply to the switch controller 302 the average value of the voltages generated at the ends of the series resistors 320 that are not open. In another example, the current detector 304 may supply to the switch controller 302 the sum of the voltages generated at the ends of the individual series resistors 320.

In an additional example, a plurality of light sources 104 may be turned on by controlling a voltage to be applied to these light sources. However, in this case, the control process would be complicated because of a variance in the forward voltage of the light-emitting diode devices 12 (see FIG. 1). However, according to the embodiment, since a current flowing through the individual light sources 104 is controlled, the multiple light sources 104 can be appropriately turned on.

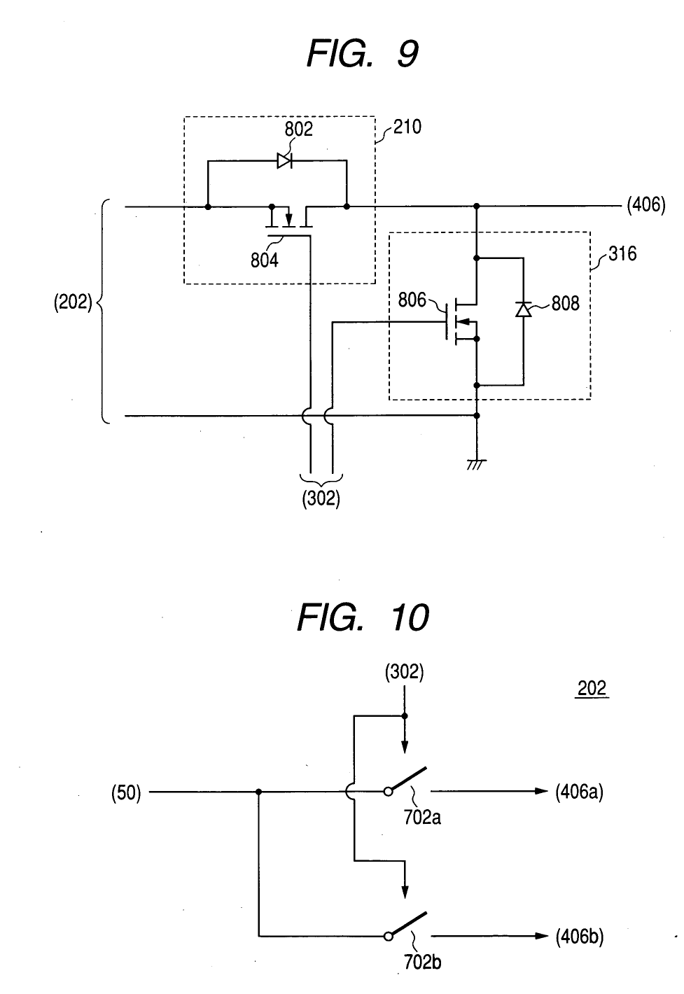

FIG. 9 is a diagram showing another example structure for the output current supply unit 210 and the inductance current supply unit 316. In this example, the output current supply unit 210 includes a diode 802 and an NMOS transistor 804, and the leakage inductance current supply unit 316 includes a diode 808 and an NMOS transistor 806.

The diodes 802 and 808 have the same functions as the output current supply unit 210 and the inductance current leakage supply unit 316 in FIG. 1. The NMOS transistor 804 and the NMOS transistor 806 are rendered on or off, by the switching controller 302, in synchronization with the switching device 312 (see FIG. 1). In this example, during a period wherein the switching device 312 is on, the NMOS transistor 804 is rendered on, and with the diode 802, supplies a current to the output coil 406. During the period wherein the switching device 312 is off, the NMOS transistor 806 is rendered off, and with the diode 808, supplies a current to the output coil 406. In this manner, the NMOS transistors 804 and 806 perform synchronous rectification with the diodes 802 and 808. As a result, compared with rectification that uses only the diodes 802 and 804, the power loss can be reduced. The diodes 802 and 804 may be parasitic diodes for NMOS transistors.

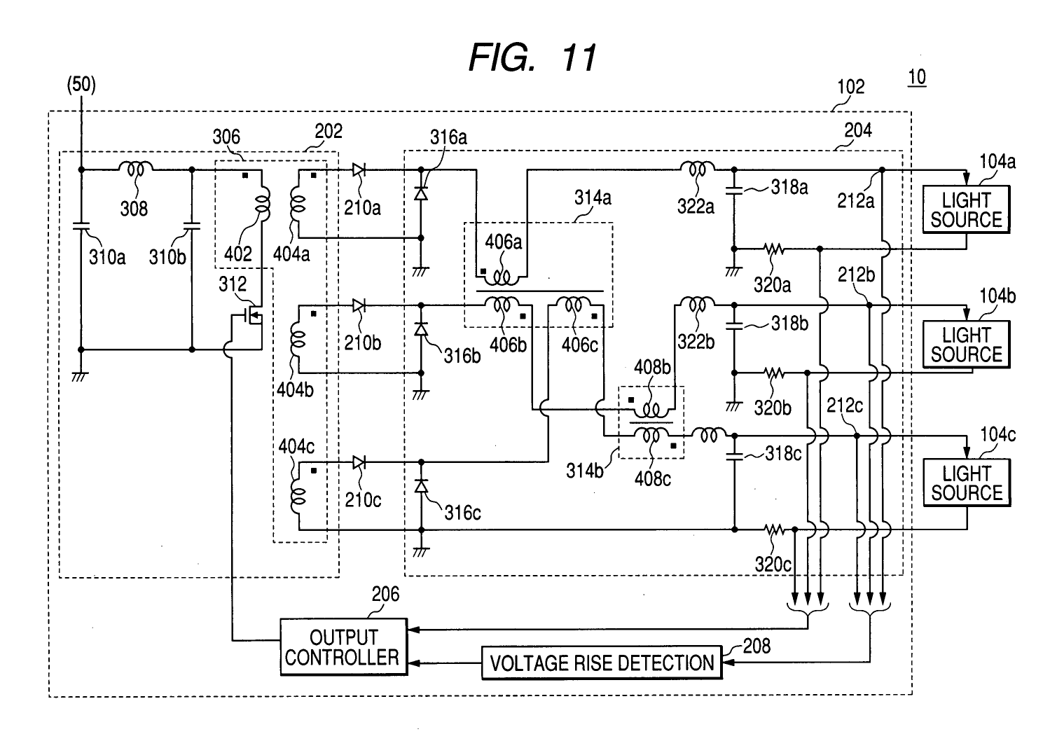

FIG. 10 is a diagram showing an additional example for the structure of the voltage output unit 202. In this example, the voltage output unit 202 includes a plurality of switches 702a and 702b, provided in correspondence with the light sources 104a and 104b (see FIG. 1). The switches 702 are used to connect the corresponding coils 406 for the reference voltage power source 50 in accordance with an instruction issued by the switch controller 302. In this case, the switch controller 302 turns on or off the switches 702a and 702b synchronously and simultaneously. The output coils receive, from the corresponding switches 702, rectangular waves consonant with the control by the switch controller 302. In this example, the ratio of the currents flowing through the output coils 406a and 406b can also be appropriately designated by using the output coils.

FIG. 11 is a diagram showing an additional example for the structure of the vehicle lamp 10. Since the components in FIG. 11 denoted by the same reference numerals as used in FIG. 1 have the same or corresponding functions, no further explanation for them will be given, except for the following components. The vehicle lamp 10 includes a plurality of light sources 104a to 104c. Corresponding to the light sources 104a to 104c, the power supply transformer 306 includes a plurality of secondary coils 404a to 404c, a plurality of output current supply units 210a to 210c, a plurality of leakage inductance current supply units 316a to 316c, a plurality of capacitors 318a to 318c and a plurality of series resistors 320a to 320c.

In this example, the voltage rise detector 208 detects not only voltages at nodes 212a and 212b, but also a voltage at a node 212c located between the light source 104c and a coil 322c corresponding to the light source 104c.

The current ratio setup unit 204 includes output transformers 314a and 314b, the number of which is smaller by one than the number of light sources 104. The output transformer 314a includes a plurality of output coils 406a, 406b and 406c, and the output transformer 314b includes a plurality of output coils 408b and 408c. The output coil 406a that is provided, and which corresponds to the light source 104a, is connected in series to the light source 104a via the coil 322a. The output coils 406b and the output coil 408b that are provided, and which correspond to the light source 104b, and are connected in series to the light source 104b through the coil 322b. And the output coil 406c and the output coil 408c that are provided, and which correspond to the light source 104c, are connected in series to the light source 104c through the coil 322c.

The output transformer 314a and 314b will now be described in more detail. In the output transformer 314a, the output coils 406b and 406c are wound in the same direction, in the opposite direction to the output coil 406a. Therefore, in accordance with a current that the voltage output unit 202 supplies to the corresponding light sources 104, the output coil 406a and the output coils 406b and 406c generate magnetic fluxes in a direction in which the magnetic fluxes cancel each other. In this case, the output coil 406a determines the ratio of the current flowing through the light source 104a to the current flowing through the light sources 104b and 104c. Furthermore, the output transformer 314a determines the rate, of the total current output by the power supply transformer 306, of the current to be supplied to the light source 104a.

When the numbers of turns of the output coils 406a, 406b and 406c are defined as Nₒ₁, Nₒ₂ and Nₒ₃, and when the currents flowing through the light sources 104a, 104b and 104c are defined as Iₒ₁, Iₒ₂ and Iₒ₃, the relation Iₒ₁=(Nₒ₂·Iₒ₂+Nₒ₃·Iₒ₃)/Nₒ₁ is established. The ratio of Iₒ₂ to Iₒ₃ is determined by the output transformer 314b.

In the output transformer 314b, the output coil 408b and the output coil 408c are wound in opposite directions. Therefore, in the current that the voltage output unit 202 supplies to the corresponding light sources 104, the output coils 408b and the output coils 408c generate magnetic fluxes in directions in which the magnetic fluxes cancel each other. Thus, the output transformer 314b determines the ratio of the current flowing through the light source 104b to the current flowing through the light source 104c. Further, other than the light source 104a, the output transformer 314b also determines the rate of the current, of the total current output by the power supply transformer 306, supplied to the light sources 104b and 104c. As a result, according to this example, even when the vehicle lamp 10 has three or more light sources 104, the current flowing through the light sources 104 can be appropriately designated.

As another example, for the vehicle lamp 10, first to N light sources 104 (N is an integer of two or greater) may be provided. In this case, the voltage output unit 202 applies a voltage to the N light sources 104 connected in parallel. For the power supply device 102, (N−1), first to (H−1)th, output transformers 314 are located between the voltage output unit 202 and the light sources 104.

The k-th (k is an integer satisfying 1≦k≦N−1) output transformer 314 includes: output coils 406 connected in series to the k-th light source 104, and (N−k) output coils 406, which are connected in series to the (k+1) th to the Nth light sources 104. In accordance with a current received from the voltage output unit 202, the (N−k) output coils 406 generate magnetic fluxes in a direction in which the magnetic fluxes generated by the output coils connected in series to the k-th light source 104 are canceled. With this arrangement, the ratio of the current flowing through the N light sources 104 can be appropriately designated.

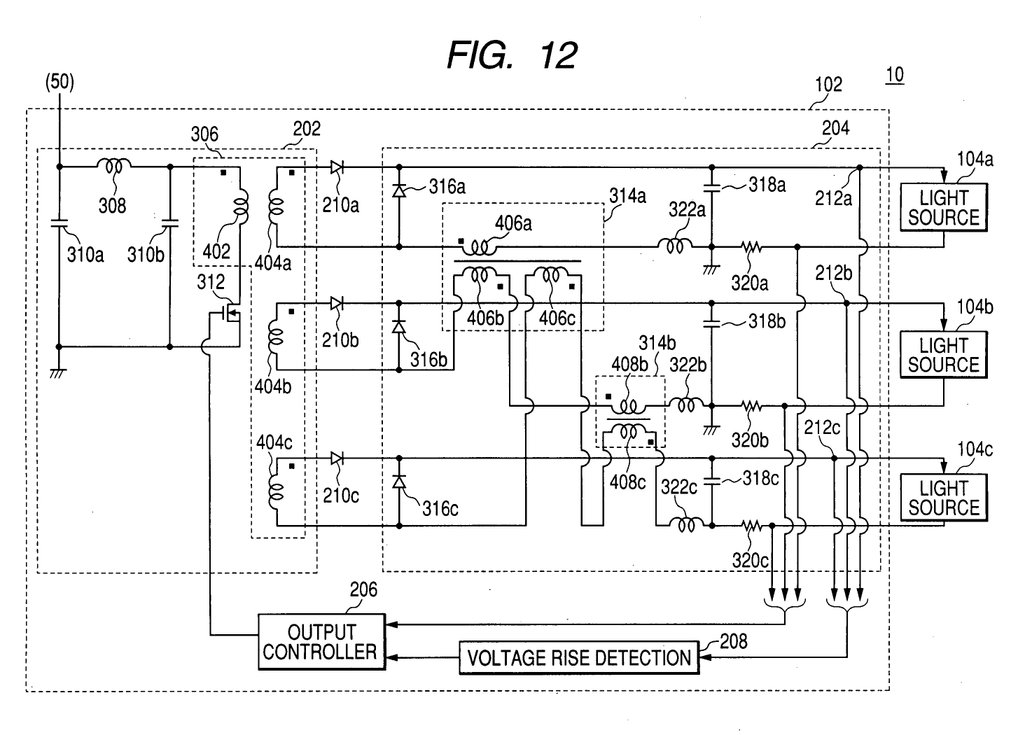

FIG. 12 is a diagram showing an additional example for the structure of the vehicle lamp 10. Since the components in FIG. 12 denoted by the same reference numerals as are used in FIG. 1 or 11 have the same or corresponding functions, no further explanation for them will be given. In this example, the output coils 406 and 408 are provided downstream of the corresponding light sources 104, and the output coils are located downstream of corresponding series resistors 320. Further, the downstream ends of the series resistors are grounded. In this case, the ratio of the current flowing through the light sources 104 can also be appropriately designated.

As a further example, the cathode of the output current supply unit 210 may be grounded. In this example, the power supply transformer 306 outputs a negative voltage at the low potential output terminal of the secondary coil 404. In this case, the ratio of the current flowing through the light sources 104 can also be appropriately designated.

As is apparent from the above description, according to one embodiment of the invention, at each switch time for the switching device 312, the output controller 206 reduces to zero the minimum value of the current that flows through the secondary coil 404, so that the current can be supplied to the light sources 104 at a desired ratio. Further, since the output controller 206 increases, to more than twice the target value of the output current, the maximum value of the current that flows through the secondary coil 404, even when the minimum value of the current flowing through the secondary coil 404 is zero, the average value of the current supplied to the light sources 104 can easily be moved near the target value.

Furthermore, since the output controller 206 changes the switching frequency in accordance with the voltage supplied to the power supply transformer 306 and maintains the constant average current for the secondary coil 404, the average value of the current for the secondary coil 404 can be maintained without changing the maximum value of the current flowing through the secondary coil 404 at the time the switching device 312 is switched. In addition, when the target current supplied to the light source 104 is increased, the output controller 206 reduces the switching frequency for the switching device 312 and increases the average current for the secondary coil 404. Thus, the average value of the current for the secondary coil can be increased without changing the rate for increasing the current flowing through the secondary coil 404 at the time the switching device 312 is switched.

The invention has been described by exemplary embodiments; however, the technical scope of the invention is not limited to these embodiments. It will be obvious for one having ordinary skill in the art that these embodiments can be variously modified or improved, and that such modifications or improvements are also included in the spirit of the invention Accordingly, the invention is limited only by the attached claims.

1. A power supply device having a switching regulator, comprising:
a regulator transformer;
a primary switch for selectively supplying a current to the regulator transformer;
a control circuit for reducing to 0, following each selection made at the primary switch, the minimum value of a current output by the secondary side of the regulator transformer; and
a coupling transformer for magnetically coupling routes along which a plurality of loads are connected in parallel to the secondary side of the regulator translator in a direction in which magnetic flux along each of the routes is offset by a current change.

2. A power supply device according to claim. 1, wherein the control circuit increases a maximum value for the current output by the secondary side until larger than twice the target value of the currents to be supplied to the loads.

3. A power supply device according to claim 2, wherein the control circuit changes switching frequencies in accordance with a voltage supplied by the primary side, the average current on the secondary side is maintained, regardless of the voltage supplied by the primary side.

4. A power supply device according to claim 3, wherein, when a target value for a current to be supplied for the loads is increased, the control circuit reduces a switching frequency for the primary switch to increase the average current on the secondary side.

5. A power supply device according to claim 4, wherein, regardless of the target value of the current to be supplied for the loads, or the supply voltage on the primary side, the control circuit is maintained substantially constant for a period wherein the current output by the secondary side is 0 during a switching cycle time.

6. A vehicle lamp having a switching regulator, comprising:
a regulator transformer;
a primary switch for selectively supplying a current to the regulator transformer;
a plurality of semiconductor light-emitting devices connected in parallel to a secondary side of the regulator transformer;
a control circuit for reducing to 0, each time a selection is made using the primary switch, the minimum value of a current output by the secondary side of the regulator transformer; and
a coupling transformer for magnetically coupling routes for the individual semiconductor light-emitting devices in a direction in which magnetic flux is offset by a current change.

7. A vehicle lamp according to claim 6, wherein, regardless of the target value of the current to be supplied for the semiconductor light-emitting devices, or the supply voltage on the primary side, the control circuit is maintained substantially constant for a period wherein the current output by the secondary side is 0 during a switching cycle time.
